(19) United States
(12) Patent Application Publication
(10) Pub. No.: US 2026/0166796 A1
(43) Pub. Date: Jun. 18, 2026

(54) INJECTION MOLDING MACHINE AND CONTROL DEVICE

(71) Applicant: SUMITOMO HEAVY INDUSTRIES, LTD., Tokyo (JP)

(72) Inventor: Yuta NESAKI, Chiba (JP)

(21) Appl. No.: 19/360,234

(22) Filed: Oct. 16, 2025

(30) Foreign Application Priority Data
Dec. 18, 2024 (JP) 2024-221386

(51) Int. Cl. B29C 45/80; B29C 45/66; B29C 45/76

(52) U.S. Cl. CPC B29C 45/80; B29C 45/661; B29C 45/7653; B29C 2945/76083; B29C 2945/76224; B29C 2945/76568; B29C 2945/76598; B29C 2945/76702

(57) ABSTRACT

An injection molding machine includes a mold clamping device including a movable part configured to open and close a mold device, and a control device operatively connected to the movable part. The control device includes one or more processors, and a memory storing programmed instructions, which when executed the one or more processors, cause the control device to control a position of the movable part in both a mold opening direction and a mold closing direction of the mold device so as to perform (a) a decompression operation of moving the movable part from a decompression start position to a mold opening start position, and (b) a mold opening operation of moving the movable part in the mold opening direction upon the movable part reaching the mold opening start position.

### CROSS-REFERENCE TO RELATED APPLICATIONS

This application is based upon and claims priority to Japanese Patent Application No. 2024-221386, filed on Dec. 18, 2024, the entire contents of which are incorporated herein by reference.

### BACKGROUND

### 1. Technical Field

The present disclosure relates to an injection molding machine and a control device.

### 2. Description of Related Art

In the related art, an injection molding machine including a mold clamping device configured to open and close a mold device, and a control device configured to control respective components of the injection molding machine, are known.

### SUMMARY

According to an embodiment of the present disclosure, an injection molding machine is provided. The injection molding machine includes:

a mold clamping device including a movable part configured to open and close a mold device; and

a control device operatively connected to the movable part, wherein the control device includes:

one or more processors; and

a memory storing programmed instructions, which when executed the one or more processors, cause the control device to control a position of the movable part in both a mold opening direction and a mold closing direction of the mold device so as to perform:

(a) a decompression operation of moving the movable part from a decompression start position to a mold opening start position; and

(b) a mold opening operation of moving the movable part in the mold opening direction upon the movable part reaching the mold opening start position.

### BRIEF DESCRIPTION OF THE DRAWINGS

FIG. 1 is a diagram illustrating a state of an injection molding machine when mold opening is completed.

FIG. 2 is a diagram illustrating a state of the injection molding machine during mold clamping.

FIG. 3 is a time chart illustrating an example of a molding cycle of the injection molding machine.

FIG. 4 is a graph illustrating a change in the position of a movable part constituting a mold clamping device of the injection molding machine.

FIG. 5 is a graph illustrating a change in the position of the movable part constituting the mold clamping device of the injection molding machine.

FIG. 6 is a graph illustrating a change in the position of the movable part constituting the mold clamping device of the injection molding machine.

### DETAILED DESCRIPTION

According to the present disclosure, an injection molding machine and a control device capable of smoothly transitioning from decompression to mold opening is provided.

According to the embodiment of the present disclosure, it is possible to provide an injection molding machine and a control device that can smoothly transition from decompression to mold opening.

Embodiments of an injection molding machine and a control device according to the present disclosure will be described below with reference to the accompanying drawings. The embodiments described below are illustrative and do not limit the invention. All features and combinations thereof in the embodiments of the present disclosure are not necessarily essential to the invention. In the drawings, the same or corresponding components are denoted by the same or corresponding reference numerals, and duplicate descriptions may be omitted.

### (Injection Molding Machine)

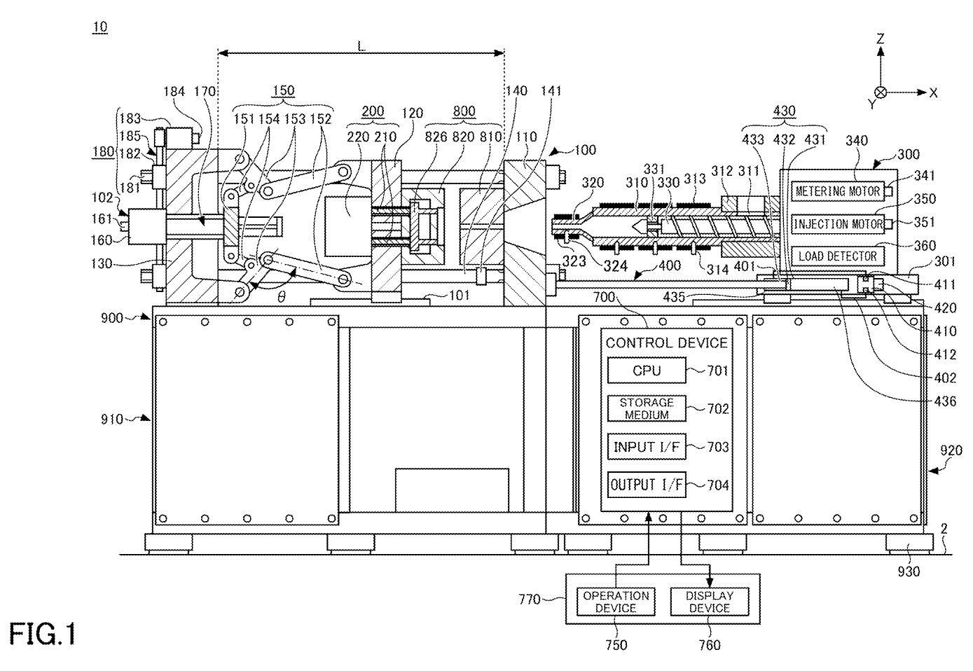

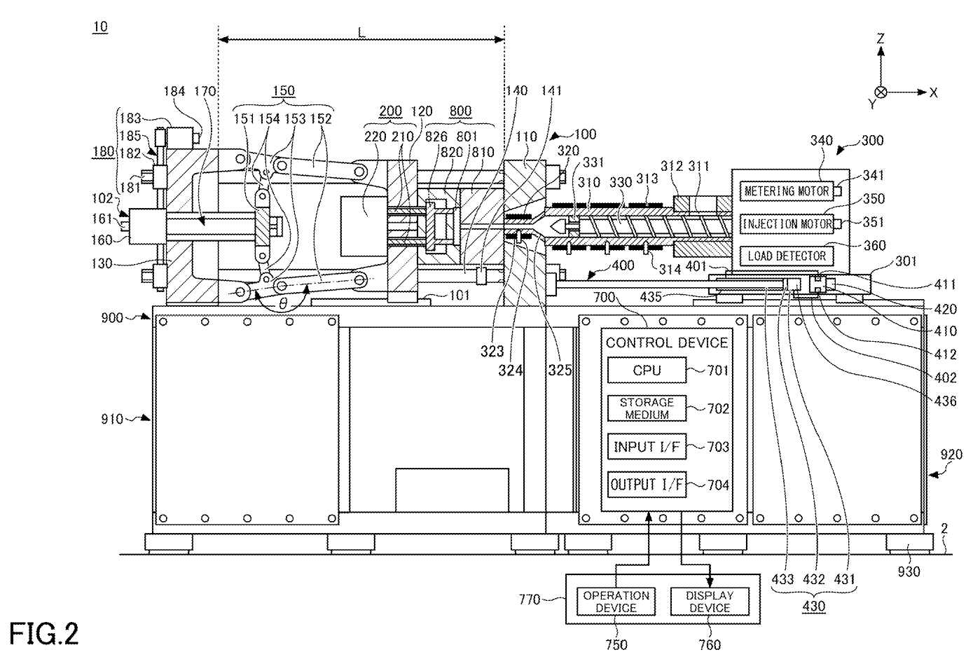

FIG. 1 is a diagram illustrating a state of an injection molding machine according to one embodiment of the present disclosure when mold opening is completed. FIG. 2 is a diagram illustrating a state of the injection molding machine of the embodiment of FIG. 1 during mold clamping. In the present specification, the X-, Y-, and Z-directions are mutually perpendicular. The X- and Y-directions represent horizontal directions, and the Z-direction represents a vertical direction. When the mold clamping device 100 is of a horizontal type, the X-direction corresponds to the mold opening and closing direction, and the Y-direction corresponds to the width direction of the injection molding machine 10. The negative side of the Y-direction is referred to as the operator side, and the positive side of the Y-direction is referred to as the non-operator side.

As illustrated in FIGS. 1 and 2, the injection molding machine 10 includes a mold clamping device 100 configured to open and close the mold device 800, an ejector device 200 configured to eject a molded product formed in the mold device 800, and an injection device 300 configured to inject a molding material into the mold device 800. The injection molding machine 10 also includes a moving device 400 configured to advance and retract the injection device 300 relative to the mold device 800, a control device 700 configured to control respective components of the injection molding machine 10, and a frame 900 configured to support respective components of the injection molding machine 10. The frame 900 includes a mold clamping device frame 910 configured to support the mold clamping device 100, and an injection device frame 920 configured to support the injection device 300. The mold clamping device frame 910 and the injection device frame 920 are respectively installed on the floor 2 via a leveling adjuster 930. The control device 700 is disposed in the internal space of the injection device frame 920. Each component of the injection molding machine 10 will be described below.

### (Mold Clamping Device)

In the description of the mold clamping device 100, the movement direction of the movable platen 120 at the time of mold closing (e.g., in the positive X-axis direction) will be described as the forward direction, and the movement direction of the movable platen 120 at the time of mold opening (e.g., in the negative X-axis direction) will be described as the rearward direction.

The mold clamping device 100 closes, boosts pressure, clamps, decompresses, and opens the mold device 800. The mold device 800 includes a fixed mold 810 and a movable mold 820.

The mold clamping device 100 is, for example, a horizontal type, and the mold opening and closing direction is horizontal. The mold clamping device 100 includes a fixed platen 110 to which the fixed mold 810 is attached, a movable platen 120 to which a movable mold 820 is attached, and a moving mechanism 102 configured to move the movable platen 120 with respect to the fixed platen 110 in the mold opening and closing direction.

The fixed platen 110 is fixed to the mold clamping device frame 910. The fixed mold 810 is attached to the surface of the fixed platen 110 facing the movable platen 120.

The movable platen 120 is disposed movably with respect to the mold clamping device frame 910 in the mold opening and closing direction. A guide 101 configured to guide the movable platen 120 is laid on the mold clamping device frame 910. The movable mold 820 is attached to the surface of the movable platen 120 facing the fixed platen 110.

The moving mechanism 102 closes, boosts pressure, clamps, decompresses, and opens the mold device 800 by advancing and retracting the movable platen 120 relative to the fixed platen 110. The moving mechanism 102 includes a toggle support 130 disposed at an interval from the fixed platen 110, a tie bar 140 connecting the fixed platen 110 and the toggle support 130, and a toggle mechanism 150 configured to move the movable platen 120 with respect to the toggle support 130 in the mold opening and closing direction. The moving mechanism 102 includes a clamping motor 160 configured to drive the toggle mechanism 150, a motion converting mechanism 170 configured to convert the rotational motion of the mold clamping motor 160 into a linear motion, and a mold thickness adjusting mechanism 180 configured to adjust the interval between the fixed platen 110 and the toggle support 130.

The toggle support 130 is disposed at an interval from the fixed platen 110, and is disposed on the mold clamping device frame 910 so as to be movable in the mold opening and closing direction. The toggle support 130 may be disposed movably along a guide laid on the mold clamping device frame 910. The guide for the toggle support 130 may be the same as the guide 101 for the movable platen 120.

In this embodiment, the fixed platen 110 is fixed to the mold clamping device frame 910, and the toggle support 130 is disposed movably relative to the mold clamping device frame 910 in the mold opening and closing direction. The toggle support 130 may be fixed to the mold clamping device frame 910, and the fixed platen 110 may be disposed movably in the mold opening and closing direction relative to the mold clamping device frame 910.

The tie bars 140 connect the fixed platen 110 and the toggle support 130 with an interval L in the mold opening and closing direction. A plurality of tie bars 140 (e.g., 4) may be used. The plurality of tie bars 140 are disposed in parallel to the mold opening and closing direction and extend according to the mold clamping force. At least one tie bar 140 may be provided with a tie bar strain detector 141 configured to detect the strain of the tie bar 140. The tie bar strain detector 141 sends a signal indicating the detection result to the control device 700. The detection result of the tie bar strain detector 141 is used to detect the mold clamping force.

In this embodiment, the tie bar strain detector 141 is used as the mold clamping force detector configured to detect the mold clamping force, but the present disclosure is not limited thereto. The mold clamping force detector is not limited to the strain gauge type, but may be a piezoelectric type, capacitive type, hydraulic type, electromagnetic type, etc., and its mounting position is not limited to the tie bar 140.

The toggle mechanism 150 is disposed between the movable platen 120 and the toggle support 130, and moves the movable platen 120 in the mold opening and closing direction relative to the toggle support 130. The toggle mechanism 150 includes a crosshead 151 configured to move in the mold opening and closing direction, and a pair of link groups that extend and contract in response to movement of the crosshead 151. Each pair of link groups includes a first link 152 and a second link 153 that are flexibly connected to each other by a pin or the like. The first link 152 is swingably attached to the movable platen 120 by a pin or the like. The second link 153 is swingably attached to the toggle support 130 by a pin or the like. The second link 153 is attached to the crosshead 151 via a third link 154. When the crosshead 151 advances and retracts relative to the toggle support 130, the first link 152 and the second link 153 extend and contract, thereby advancing and retracting the movable platen 120 relative to the toggle support 130.

The configuration of the toggle mechanism 150 is not limited to the configuration illustrated in FIGS. 1 and 2. For example, in FIGS. 1 and 2, the number of nodes of each link group is 5, but 4 may be used, and one end of the third link 154 may be connected to the nodes of the first link 152 and the second link 153.

The mold clamping motor 160 is attached to the toggle support 130 and drives the toggle mechanism 150. By advancing and retracting the crosshead 151 relative to the toggle support 130, the mold clamping motor 160 causes the first link 152 and the second link 153 to extend and contract, thereby advancing and retracting the movable platen 120 relative to the toggle support 130. The mold clamping motor 160 is directly connected to a motion conversion mechanism 170, but may alternatively be connected to the motion conversion mechanism 170 via a belt, a pulley, or the like.

The motion conversion mechanism 170 converts the rotational motion of the mold clamping motor 160 into the linear motion of the crosshead 151. The motion conversion mechanism 170 includes a screw shaft and a screw nut screwed with the screw shaft. A ball or a roller may be interposed between the screw shaft and the screw nut.

The mold clamping device 100 performs the mold closing step, the pressure boosting step, the mold clamping step, the decompression step, and the mold opening step under the control of the control device 700.

In the mold closing step, the mold clamping motor 160 is driven to advance the crosshead 151 to the mold closing completion position at a set moving speed, thereby advancing the movable platen 120 and touching the movable mold 820 to the fixed mold 810. The position and the moving speed of the crosshead 151 are detected using, for example, the mold clamping motor encoder 161. The mold clamping motor encoder 161 detects the rotation of the mold clamping motor 160 and sends a signal indicating the detection result to the control device 700.

The crosshead position detector configured to detect the position of the crosshead 151 and the crosshead moving speed detector configured to detect the moving speed of the crosshead 151 are not limited to the mold clamping motor encoder 161, and general detectors may be used. The movable platen position detector configured to detect the position of the movable platen 120 and the movable platen moving speed detector configured to detect the moving speed of the movable platen 120 are not limited to the mold clamping motor encoder 161, and general detectors may be used.

In the pressure boosting step, the mold clamping force is generated by further driving the mold clamping motor 160 to further advance the crosshead 151 from the mold closing completion position to the mold clamping position.

In the mold clamping step, the mold clamping motor 160 is driven to maintain the position of the crosshead 151 at the mold clamping position. In this step, the clamping force generated in the pressure boosting step is maintained. During the mold clamping step, a cavity space 801 (see FIG. 2) is formed between the movable mold 820 and the fixed mold 810, and the injection device 300 fills the cavity space 801 with a liquid molding material. By solidifying the filled molding material, a molded product is obtained.

The number of cavity spaces 801 may be one or more. In the latter case, a plurality of moldings are obtained simultaneously. An insert material may be placed in a part of the cavity space 801, and the molding material may be filled into another part of the cavity space 801. In this way, a molded product in which the insert material and the molding material are integrated can be obtained.

In the decompression step, the mold clamping motor 160 is driven to retract the crosshead 151 from the clamping position to the mold opening start position, thereby retracting the movable platen 120 and reducing clamping force. The mold opening start position and the mold closing completion position may be at the same position.

In the mold opening step, the mold clamping motor 160 is driven to retract the crosshead 151 from the mold opening start position to the mold opening completion position at a set moving speed, thereby retracting the movable platen 120 and separating the movable mold 820 from the fixed mold 810. After that, the ejector device 200 ejects the molded product from the movable mold 820.

In this embodiment, the crosshead 151 is a movable part configured to move in the mold opening and closing direction of the mold 800 and to open and close the mold 800 by controlling the rotation of the mold clamping motor 160 by the control device 700. The control device 700 controls the position of the crosshead 151 in the mold opening and closing direction of the mold 800 to perform decompression and mold opening. The control device 700 controls the position of the crosshead 151 based on the detection result of the mold clamping motor encoder 161 as a position detector which detects the position of the crosshead 151 as a movable part, for example.

It should be noted that the movable part of the mold clamping device 100 configured to open and close the mold device 800 is not limited to the crosshead 151. For example, when the mold clamping device 100 includes a hydraulic cylinder for mold clamping instead of the toggle mechanism 150, the movable part of the mold clamping device 100 may be a piston rod of the hydraulic cylinder configured to open and close the mold device 800. In addition, the movable platen 120, which is moved in the mold opening and closing direction by the toggle mechanism 150, the hydraulic cylinder, or the like to open and close the mold device 800, may also serve as the movable part of the mold clamping device 100.

The setting conditions in the mold closing step, the pressure boosting step, and the clamping step are set collectively as a series of setting conditions. For example, the moving speed, position (including mold closing start position, moving speed switching position, mold closing completion position, and mold clamping position), and clamping force of the movable parts such as the crosshead 151 in the mold closing step and the pressure boosting step are set collectively as a series of setting conditions. The mold closing start position, the moving speed switching position, the mold closing completion position, and the clamping position are disposed in this order from the rear side toward the front, and represent the start point and end point of the section where the moving speed is set. The moving speed is set for each section. The moving speed switching position may be one or more. The moving speed switching position may not be set. Only one of the clamping position and clamping force may be set.

The setting conditions in the decompression step and the mold opening step are similarly set. For example, the moving speed and position of the movable part such as the crosshead 151 in the decompression step and the mold opening step (including the mold opening start position, the moving speed switching position, and the mold opening completion position) are collectively set as a series of setting conditions. The mold opening start position, the moving speed switching position, and the mold opening completion position are arranged in this order from the front side toward the rear side, and represent the starting point or ending point of a section in which the moving speed is set. The moving speed is set for each section. The moving speed switching position may be one or more, or moving speed switching position may not be set. The mold opening start position and the mold closing completion position may be the same position. Similarly, the mold opening completion position and the mold closing start position may be the same position.

The moving speed and position of the movable platen 120 as a movable part configured to open and close the mold device 800 may be set, instead of the moving speed and position of the crosshead 151. In addition, the mold clamping force may be set, instead of the position of the crosshead (e.g., the mold clamping position) or the position of the movable platen.

The toggle mechanism 150 amplifies the driving force of the mold clamping motor 160 and transmits it to the movable platen 120. The amplification factor is also called a toggle factor. The toggle factor changes according to the angle θ (hereinafter also referred to as “link angle θ”) formed between the first link 152 and the second link 153. The link angle θ is obtained from the position of the crosshead 151. When the link angle θ becomes 180°, the toggle factor is maximized.

When the thickness of the mold device 800 changes due to replacement of the mold device 800 or temperature change of the mold device 800, mold thickness adjustment is performed so as to obtain a predetermined mold clamping force during mold clamping. In the mold thickness adjustment, for example, the interval L between the fixed platen 110 and the toggle support 130 is adjusted so that the link angle θ of the toggle mechanism 150 becomes a predetermined angle at the time of mold touch when the movable mold 820 touches the fixed mold 810.

The mold clamping device 100 includes a mold thickness adjustment mechanism 180. The mold thickness adjustment mechanism 180 adjusts the interval L between the fixed platen 110 and the toggle support 130 to adjust the mold thickness. The timing of mold thickness adjustment is performed, for example, between the end of the molding cycle and the start of the next molding cycle. The mold thickness adjustment mechanism 180 includes, for example, a screw shaft 181 formed at the rear end of the tie bar 140, a screw nut 182 rotatably held by the toggle support 130 in a non-retractable manner, and a mold thickness adjustment motor 183 for rotating the screw nut 182 screwed with the screw shaft 181.

The screw shaft 181 and the screw nut 182 are provided for each tie bar 140. The rotational driving force of the mold thickness adjustment motor 183 may be transmitted to a plurality of screw nuts 182 via a rotational driving force transmission part 185. The plurality of screw nuts 182 can be rotated synchronously. It is also possible to rotate the plurality of screw nuts 182 individually by changing the transmission path of the rotational driving force transmission part 185.

The rotational driving force transmission part 185 is composed of, for example, gears. In this case, a driven gear is formed on the outer circumference of each screw nut 182, and a driving gear is attached to the output shaft of the mold thickness adjustment motor 183. Moreover, the plurality of driven gears and an intermediate gear meshed with the driving gear are rotatably held at the center of the toggle support 130. The rotational driving force transmission part 185 may be composed of, instead of gears, a belt or pulley.

The operation of the mold thickness adjustment mechanism 180 is controlled by the control device 700. The control device 700 drives the mold thickness adjustment motor 183 to rotate the screw nut 182. As a result, the position of the toggle support 130 relative to the tie bar 140 is adjusted, and the interval L between the fixed platen 110 and the toggle support 130 is adjusted. A plurality of mold thickness adjusting mechanisms may be used in combination.

The interval L is detected using a mold thickness adjustment motor encoder 184. The mold thickness adjustment motor encoder 184 detects the amount and direction of rotation of the mold thickness adjustment motor 183 and sends a signal indicating the detection result to the control device 700. The detection result of the mold thickness adjustment motor encoder 184 is used to monitor and control the position of the toggle support 130 and the interval L. It should be noted that the toggle support position detector configured to detect the position of the toggle support 130 and the interval detector configured to detect the interval L are not limited to the mold thickness adjustment motor encoder 184, and general detectors may be employed.

The mold clamping device 100 may include a mold temperature controller configured to adjust the temperature of the mold device 800. The mold device 800 has a flow path for a heat transfer medium inside it. The mold temperature controller adjusts the temperature of the mold device 800 by regulating the temperature of the heat transfer medium supplied to the flow path of the mold device 800.

It should be noted that, although the mold clamping device 100 according to the present embodiment is a horizontal type in which the mold opening and closing direction is horizontal, it may be a vertical type in which the mold opening and closing direction is vertical.

The mold clamping device 100 according to the present embodiment includes a mold clamping motor 160 as a drive part. However, the mold clamping device 100 may include a hydraulic cylinder instead of the mold clamping motor 160. The mold clamping device 100 may also include a linear motor for mold opening and closing and an electromagnet for mold clamping.

### (Ejector Device)

In the description of the ejector device 200, as in the description of the mold clamping device 100, the movement direction of the movable platen 120 at the time of mold closing (e.g., in the positive X-axis direction) is referred to as a forward direction and the movement direction of the movable platen 120 at the time of mold opening (e.g., in the negative X-axis direction) is referred to as a rearward direction.

The ejector device 200 is attached to the movable platen 120 and advances and retracts together with the movable platen 120. The ejector device 200 includes an ejector rod 210 for pushing the molded product out of the mold device 800, and a drive mechanism 220 for moving the ejector rod 210 in the movement direction (X-axis direction) of the movable platen 120.

The ejector rod 210 is disposed in a through hole of the movable platen 120 so as to be able to advance and retract. The front end of the ejector rod 210 contacts the ejector plate 826 of the movable mold 820. The front end of the ejector rod 210 may or may not be connected to the ejector plate 826.

The drive mechanism 220 includes, for example, an ejector motor and a motion conversion mechanism configured to convert the rotational motion of the ejector motor into the linear motion of the ejector rod 210. The motion conversion mechanism includes a screw shaft and a screw nut screwed to the screw shaft. A ball or a roller may be interposed between the screw shaft and the screw nut.

The ejector device 200 performs an ejecting step under the control of the control device 700. In the ejecting step, the ejector plate 826 is advanced by advancing the ejector rod 210 from the standby position to the ejection position at the set moving speed, and the molded product is ejected. Then, the ejector motor is driven to retract the ejector rod 210 at the set moving speed, and the ejector plate 826 is retracted to the original standby position.

The position and the moving speed of the ejector rod 210 are detected using, for example, an ejector motor encoder. The ejector motor encoder detects the rotation of the ejector motor and sends a signal indicating the detection result to the control device 700. The ejector rod position detector configured to detect the position of the ejector rod 210 and the ejector rod moving speed detector configured to detect the moving speed of the ejector rod 210 are not limited to the ejector motor encoder, and general detectors may be used.

### (Injection Device)

In the description of the injection unit 300, unlike the descriptions of the mold clamping unit 100 and the ejector unit 200, the movement direction of the screw 330 during filling (e.g., the negative X-axis direction) is described as forward, and the movement direction of the screw 330 during metering (e.g., the positive X-axis direction) is described as rearward.

The injection device 300 is installed on a slide base 301, and the slide base 301 is disposed to be advanceable and retractable with respect to an injection device frame 920. The injection device 300 is also disposed to be advanceable and retractable with respect to the mold device 800. The injection device 300 comes into contact with the mold device 800 and fills a cavity space 801 in the mold device 800 with molding material. The injection device 300 includes, for example, a cylinder 310 that heats the molding material, a nozzle 320 provided at a front end of the cylinder 310, and a screw 330 disposed within the cylinder 310 so as to be advanceable, retractable, and rotatable. The injection device 300 further includes a metering motor 340 configured to rotate the screw 330, an injection motor 350 configured to advance and retract the screw 330, and a load detector 360 configured to detect a load transmitted between the injection motor 350 and the screw 330.

The cylinder 310 heats the molding material supplied inside from the supply port 311. The molding material includes, for example, resin. The molding material is formed, for example, into pellets, and is supplied to the supply port 311 in a solid state. The supply port 311 is formed at a rear portion of the cylinder 310. A cooler 312 such as a water-cooled cylinder is provided at the outer circumference of the rear portion of the cylinder 310. A first heater 313 such as a band heater and a first temperature detector 314 are provided at the outer circumference of the cylinder 310 in front of the cooler 312.

The cylinder 310 is divided into a plurality of zones in the axial direction (e.g., X-axis direction) of the cylinder 310. A first heater 313 and a first temperature detector 314 are provided in each of the plurality of zones. A set temperature is assigned to each of the plurality of zones, and the control device 700 controls the first heater 313 so that the detection temperature of the first temperature detector 314 becomes the set temperature.

The nozzle 320 is provided at the front end of the cylinder 310 and pressed against the mold device 800. A second heater 323 and a second temperature detector 324 are provided at the outer circumference of the nozzle 320. The control device 700 controls the second heater 323 so that the temperature detected by the second temperature detector 324 is set.

The screw 330 is disposed in the cylinder 310 rotatably and retractably. When the screw 330 is rotated, the molding material is sent forward along the helical groove of the screw 330. While being sent forward, the molding material is gradually melted by the heat from the cylinder 310. As the liquid molding material is sent forward of the screw 330 and accumulates at the front portion of the cylinder 310, the screw 330 is retracted. Then, when the screw 330 is advanced, the liquid molding material accumulated at the front of the screw 330 is ejected from the nozzle 320 and filled into the mold device 800.

A backflow prevention ring 331 is attached to the front portion of the screw 330 in a retractable manner as a backflow prevention valve to prevent backflow of molding material from the front to the rear of the screw 330 when the screw 330 is advanced.

When the screw 330 is advanced, the backflow prevention ring 331 is pushed rearward by the pressure of the molding material in front of the screw 330 and retracts relatively to the screw 330 to a closed position (see FIG. 2) that blocks the flow path of the molding material. This prevents the molding material accumulated in front of the screw 330 from backflow backward.

On the other hand, when the screw 330 rotates, the backflow prevention ring 331 is pushed forward relative to the screw 330 by the pressure of the molding material fed forward along the helical grooves of the screw 330 and pushed forward to an open position (see FIG. 1) that opens the flow path of the molding material. This sends the molding material forward of the screw 330.

The backflow prevention ring 331 may be either a co-rotating type that rotates with the screw 330 or a non-co-rotating type that does not rotate with the screw 330.

The injection device 300 may include a drive source configured to advance and retract the backflow prevention ring 331 relative to the screw 330 between an open position and a closed position.

The metering motor 340 rotates the screw 330. The drive source for rotating the screw 330 is not limited to the metering motor 340, but may be, for example, a hydraulic pump.

The injection motor 350 advances and retracts the screw 330. Between the injection motor 350 and the screw 330, a motion conversion mechanism or the like is provided to convert the rotational motion of the injection motor 350 into the linear motion of the screw 330. The motion conversion mechanism includes, for example, a screw shaft and a screw nut threaded onto the screw shaft. A ball or roller may be interposed between the screw shaft and the screw nut. The drive source for advancing and retracting the screw 330 is not limited to the injection motor 350 and may be, for example, a hydraulic cylinder.

The load detector 360 detects the load transmitted between the injection motor 350 and the screw 330. The detected load is converted into pressure by the control device 700. The load detector 360 is provided in the load transmission path between the injection motor 350 and the screw 330, and detects the load acting on the load detector 360.

The load detector 360 sends a signal of the detected load to the control device 700. The load detected by the load detector 360 is converted into pressure acting between the screw 330 and the molding material, and is used to control and monitor the pressure received by the screw 330 from the molding material, the back pressure on the screw 330, and the pressure acting on the molding material from the screw 330.

The pressure detector configured to detect the pressure of the molding material is not limited to the load detector 360, and general detectors may be used. For example, a nozzle pressure sensor or a mold internal pressure sensor may be used. The nozzle pressure sensor is installed in the nozzle 320. The mold pressure sensor is installed inside the mold device 800.

The injection device 300 performs a metering step, a filling step, and a packing pressure step under the control of the control device 700. The filling step and the packing pressure step may be collectively called an injection step.

In the metering step, the metering motor 340 is driven to rotate the screw 330 at a set rotational speed, and the molding material is sent forward along the helical grooves of the screw 330. Accordingly, the molding material is gradually melted. As the liquid molding material is sent forward of the screw 330 and accumulated in the front portion of the cylinder 310, the screw 330 is retracted. The rotational speed of the screw 330 is detected using, for example, a metering motor encoder 341. The metering motor encoder 341 detects the rotation of the metering motor 340 and sends a signal indicating the detection result to the control device 700. The screw rotation speed detector configured to detect the rotation speed of the screw 330 is not limited to the metering motor encoder 341, and a general detector may be used.

In the metering step, in order to restrict rapid backward movement of the screw 330, the injection motor 350 may be driven to apply a set back pressure to the screw 330. The back pressure on the screw 330 may be detected, for example, using a load detector 360. When the screw 330 has retracted to the metering completion position and a predetermined amount of molding material has accumulated in front of the screw 330, the metering step is completed.

The position and rotation speed of the screw 330 in the metering step are collectively set as a series of setting conditions. For example, a metering start position, a rotation speed switching position, and a metering completion position are set. These positions are disposed in this order from the front side toward the rear side and represent start and end points of sections in which rotation speeds are set. A rotation speed is set for each section. The rotation speed switching position may be one or more, or may not be set at all. In addition, a back pressure is set for each section.

In the filling step, the injection motor 350 is driven to advance the screw 330 at a set moving speed, and the liquid molding material accumulated in front of the screw 330 is filled into the cavity space 801 in the mold device 800. The position and the moving speed of the screw 330 are detected using, for example, the injection motor encoder 351. The injection motor encoder 351 detects the rotation of the injection motor 350 and sends a signal indicating the detection result to the control device 700. When the position of the screw 330 reaches the set position, switching from the filling step to the packing pressure step (So-Called V/P switching) is performed. The position at which the V/P switching is performed is also called the V/P switching position. The set moving speed of the screw 330 may be changed according to, for example, the position of the screw 330 and time.

The position and moving speed of the screw 330 in the filling step are set together as a series of setting conditions. For example, the filling start position (Also called injection start position), the moving speed switching position, and the V/P switching position are set. These positions are disposed in this order from the rear side to the front side, and represent the start and end points of the section where the moving speed is set. The moving speed is set for each section. The moving speed switching position may be one or more, or may not be set at all.

The upper limit value of the pressure of the screw 330 is set for each section where the moving speed of the screw 330 is set. The pressure of the screw 330 is detected by the load detector 360. When the pressure of the screw 330 is less than or equal to the set pressure, the screw 330 is advanced at the set moving speed. When the pressure of the screw 330 exceeds the set pressure, the screw 330 is advanced at a moving speed slower than the set moving speed so that the pressure of the screw 330 is less than or equal to the set pressure for the purpose of mold protection.

After the position of the screw 330 reaches the V/P switching position in the filling step, the screw 330 may be temporarily stopped at the V/P switching position, and then V/P switching may be performed. Immediately before V/P switching, instead of stopping the screw 330, the screw 330 may be slightly advanced or slightly retracted. The screw position detector configured to detect the position of the screw 330 and the screw moving speed detector configured to detect the moving speed of the screw 330 are not limited to the injection motor encoder 351, and general detectors may be used.

In the packing pressure step, the injection motor 350 is driven to push the screw 330 forward, and the pressure (Hereinafter, it is also referred to as “packing pressure”.) of the molding material at the front end of the screw 330 is maintained at the set pressure, and the molding material remaining in the cylinder 310 is pushed toward the mold device 800. The molding material that is insufficient due to the cooling shrinkage in the mold device 800 can be replenished. The packing pressure is detected using, for example, a load detector 360. The set value of the packing pressure may be changed according to the elapsed time from the start of the packing pressure step. A plurality of packing pressures and a plurality of the holding times for holding a packing pressure in the packing pressure step may be set, and the packing pressures and holding times may be collectively set as a series of setting conditions.

In the packing pressure step, the molding material in the cavity space 801 in the mold device 800 is gradually cooled, and when the packing pressure step is completed, the inlet of the cavity space 801 is closed with the solidified molding material. This state is called gate seal, and the backflow of the molding material from the cavity space 801 is prevented. After the packing pressure step, a cooling step is started. In the cooling step, the molding material in the cavity space 801 is solidified. In order to shorten the molding cycle time, a metering step may be performed during the cooling step.

Although the injection device 300 according to the present embodiment is an in-line screw type, it may be a preplastic type or the like. In the preplastic type injection device, the molding material melted in the plasticizing cylinder is supplied to an injection cylinder, and the molding material is injected from the injection cylinder into the mold device. In the plasticizing cylinder, the screw is rotatably and non-retractable, or the screw is rotatably and non-retractable. Meanwhile, the plunger is rotatably and retractable in the injection cylinder.

The injection device 300 according to the present embodiment is a horizontal type in which the axial direction of the cylinder 310 is horizontal, but may be a vertical type in which the axial direction of the cylinder 310 is vertical. The mold clamping device combined with the vertical injection device 300 may be either a vertical type or a horizontal type. Similarly, the mold clamping device combined with the horizontal injection device 300 may be either a horizontal type or a vertical type.

### (Moving Device)

In the description of the moving device 400, as in the description of the injection device 300, the moving direction of the screw 330 during filling (e.g., the negative X-axis direction) is referred to as the forward direction, and the moving direction of the screw 330 during metering (e.g., the positive X-axis direction) is referred to as the rearward direction.

The moving device 400 advances and retracts the injection device 300 with respect to the mold device 800. The moving device 400 also presses the nozzle 320 against the mold device 800 to generate a nozzle touch pressure. The moving device 400 includes, for example, a hydraulic pump 410, a motor 420 as a drive source, and a hydraulic cylinder 430 as a hydraulic actuator.

The hydraulic pump 410 includes a first port 411 and a second port 412. The hydraulic pump 410 is a pump capable of rotating in both directions, and by switching the rotation direction of the motor 420, the hydraulic fluid (e.g., oil) is sucked from one of the first port 411 or the second port 412 and discharged from the other to generate hydraulic pressure. The hydraulic pump 410 can also suck the hydraulic fluid from a tank and discharge the hydraulic fluid from one of the first port 411 or the second port 412.

The motor 420 drives the hydraulic pump 410. The motor 420 drives the hydraulic pump 410 in a rotation direction and with a rotation torque corresponding to control signals from the control device 700. The motor 420 may be an electric motor, and may be an electric servomotor.

The hydraulic cylinder 430 includes a cylinder body 431, a piston 432, and a piston rod 433. The cylinder body 431 is fixed to the injection device 300. The piston 432 partitions the inside of the cylinder body 431 into a front chamber 435 as a first chamber and a rear chamber 436 as a second chamber. The piston rod 433 is fixed to the fixed platen 110.

The front chamber 435 of the hydraulic cylinder 430 is connected to a first port 411 of the hydraulic pump 410 via a first flow path 401. When hydraulic fluid discharged from the first port 411 is supplied to the front chamber 435 through the first flow path 401, the injection device 300 is pushed forward. The injection device 300 advances, and the nozzle 320 is pressed against the fixed mold 810. The front chamber 435 functions as a pressure chamber that generates nozzle touch pressure of the nozzle 320 by the pressure of the hydraulic fluid supplied from the hydraulic pump 410.

Meanwhile, the rear chamber 436 of the hydraulic cylinder 430 is connected to a second port 412 of the hydraulic pump 410 via a second flow path 402. When hydraulic fluid discharged from the second port 412 is supplied to the rear chamber 436 of the hydraulic cylinder 430 through the second flow path 402, the injection device 300 is pushed rearward. The injection device 300 retracts, and the nozzle 320 is separated from the fixed mold 810.

Although the moving device 400 includes the hydraulic cylinder 430 in this embodiment, the present disclosure is not limited thereto. For example, instead of the hydraulic cylinder 430, an electric motor and a motion conversion mechanism configured to convert the rotational motion of the electric motor to the linear motion of the injection device 300 may be used.

### (Control Device)

The control device 700 includes, for example, a computer, and as illustrated in FIGS. 1 to 2, includes a CPU (Central Processing Unit) 701, a storage medium 702 such as a memory, an input interface 703, and an output interface 704. The control device 700 performs various types of control by causing the CPU 701 to execute a program stored in the storage medium 702. The control device 700 receives signals from the outside through the input interface 703 and transmits signals to the outside through the output interface 704.

The control device 700 includes an electronic circuit such as a CPU, a FPGA (Field Programmable Gate Array), or an ASIC (Application Specific Integrated Circuit), and executes various control operations described herein by executing instruction codes stored in the memory or by designing circuits for special applications.

The control device 700 repeatedly performs the metering step, the mold closing step, the pressure boosting step, the mold clamping step, the filling step, the packing pressure step, the cooling step, the decompression step, the mold opening step, and the ejecting step to repeatedly produce molded products. A series of operations for obtaining a molded product, for example, from the start of one metering step to the start of the next metering step, is also referred to as a "shot" or a "molding cycle." The time required for one shot is also referred to as a "molding cycle time" or a "cycle time."

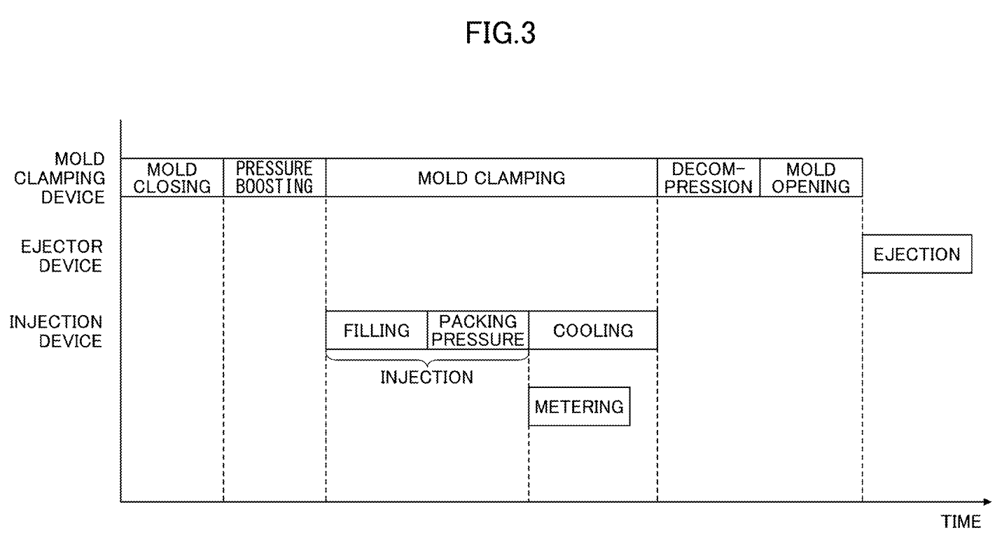

FIG. 3 is a time chart illustrating an example of a molding cycle of the injection molding machine 10. One molding cycle includes, for example, a metering step, a mold closing step, a pressure boosting, a mold clamping step, a filling step, a packing pressure step, a cooling step, a decompression step, a mold opening step, and an ejecting step, in this order. The order here refers to the order in which the respective steps start. The filling step, the packing pressure step, and the cooling step are performed during the mold clamping step. The start of the mold clamping step may coincide with the start of the filling step. The completion of the decompression step coincides with the start of the mold opening step.

It should be noted that, for the purpose of shortening the molding cycle time, a plurality of steps may be performed simultaneously. For example, the metering step may be performed during the cooling step of the previous molding cycle, and may also be performed during the mold clamping step. In this case, the mold closing step may be regarded as being performed at the beginning of the molding cycle. In addition, the filling step may be started during the mold closing step, and the ejecting step may be started during the mold opening step. When an on-off valve configured to open and close the flow path of the nozzle 320 is provided, the mold opening step may be started during the metering step. Even if the mold opening step is started during the metering step, leakage of molding material from the nozzle 320 does not occur as long as the on-off valve closes the flow path of the nozzle 320.

It should also be noted that one molding cycle may include steps other than the metering step, the mold closing step, the pressure boosting, the mold clamping step, the filling step, the packing pressure step, the cooling step, the decompression step, the mold opening step, and the ejecting step.

For example, after completion of the packing pressure step and before the start of the metering step, a pre-metering suck-back step may be performed in which the screw 330 is retracted to a predetermined metering start position. The pressure of the molding material accumulated in front of the screw 330 before the start of the metering step can be reduced, and the sudden retraction of the screw 330 at the start of the metering step can be prevented.

Further, after the completion of the metering step and before the start of the filling step, a post-metering suck-back step may be performed in which the screw 330 is retracted to a predetermined filling start position (Also called injection start position). The pressure of the molding material accumulated in front of the screw 330 before the start of the filling step can be reduced, and the leakage of the molding material from the nozzle 320 before the start of the filling step can be prevented.

The control device 700 is connected to an operation device 750 that receives input operations by a user and a display device 760 that displays a screen. The operation device 750 and the display device 760 may be integrated with, for example, a touch panel 770. The touch panel 770 as the display device 760 displays a screen under the control of the control device 700. The screen of the touch panel 770 may display information including, for example, settings of the injection molding machine 10 and the current state of the injection molding machine 10. In addition, the screen of the touch panel 770 may display, for example, an operation section such as a button or an input field that receives input operations by the user. The touch panel 770 as the operation device 750 detects an input operation on the screen by the user and outputs a signal corresponding to the input operation to the control device 700. Thus, for example, the user can set the injection molding machine 10 (including input of a set value) by operating the operation section provided on the screen while checking the information displayed on the screen. Further, by operating the operation section provided on the screen, the user can perform an operation of the injection molding machine 10 corresponding to the operation section. The operation of the injection molding machine 10 may be, for example, the operation (including stopping) of the mold clamping device 100, the ejector device 200, the injection device 300, and the moving device 400. The operation of the injection molding machine 10 may be, for example, the switching of the screen displayed on the touch panel 770 as the display device 760.

In the present embodiment, the operation device 750 and the display device 760 have been described as being integrated as the touch panel 770; however, they may be provided separately. In addition, a plurality of operation devices 750 may be provided. The operation device 750 and the display device 760 are disposed on the operation side (negative Y-axis direction) of the mold clamping device 100 , more specifically, the fixed platen 110.

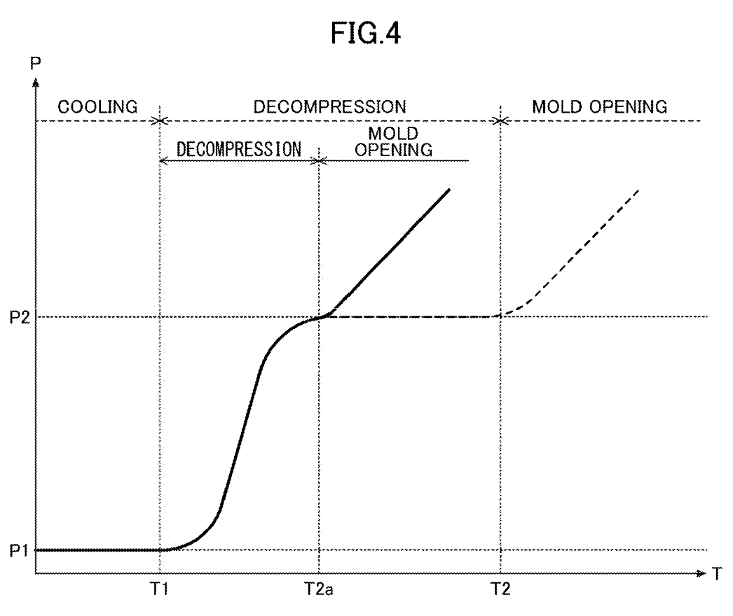

FIGS. 4 to 6 are graphs illustrating changes in the position P of the crosshead 151 as a movable part constituting the mold clamping device 100 of the injection molding machine 10. In the graphs of FIGS. 4 to 6, the vertical axis represents the position P of the crosshead 151, and the horizontal axis represents time T, showing changes in the position P of the crosshead 151 over time T during the transition from decompression to mold opening.

The injection molding machine 10 and the control device 700 of the present embodiment have the following configuration as a principal feature. As described above, the injection molding machine 10 includes the mold clamping device 100 and the control device 700. The mold clamping device 100 includes a crosshead 151 as a movable part configured to open and close the mold device 800. The control device 700 controls the position of the crosshead 151 in the mold opening and closing direction of the mold device 800 to perform decompression and mold opening. The control device 700 moves the crosshead 151 as a movable part from a decompression start position P1 to a mold opening start position P2 to perform decompression, and upon the crosshead 151 reaching the mold opening start position P2, moves the crosshead 151 in the mold opening direction to perform mold opening.

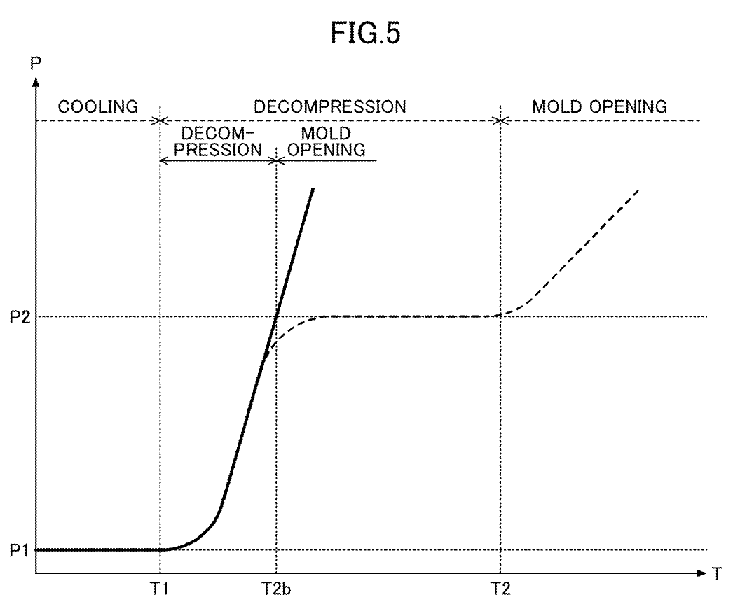

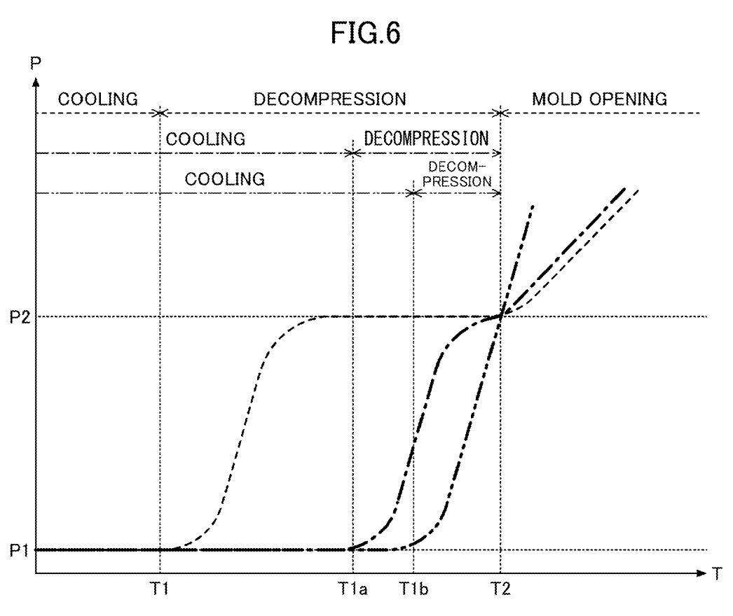

The thin broken lines illustrated in FIGS. 4 to 6 represent changes over time T in the position P of a movable part of a mold clamping device configured to open and close the mold device in a comparative example of an injection molding machine different from the injection molding machine 10 according to the present embodiment. In FIGS. 4 and 5, the thick solid lines represent changes over time T in the position P of the crosshead 151 as a movable part of the injection molding machine 10 according to the present embodiment. In FIG. 6, the thick one-dot chain line and the thick two-dot chain line represent changes over time T in the position P of the crosshead 151 as a movable part of the injection molding machine 10 according to the present embodiment.

In the comparative example of the injection molding machine, as illustrated by the thin broken line in FIG. 4, the movement of the movable part toward the mold opening start position P2 is started from the decompression start position P1 at the decompression start time T1, and the movable part reaches the mold opening start position P2 at a time T2a, which is earlier than the mold opening start time T2. Thereafter, in the comparative example, the movable part is held at the mold opening start position P2 until the mold opening start time T2, and at the mold opening start time T2, the movable part begins moving from the mold opening start position P2 toward the mold opening end position.

The decompression start position P1 of the movable part corresponds to the end position of the cooling step during which clamping force is applied to the mold device. In an injection molding machine, decompression configured to move the movable part from the decompression start position P1 to the mold opening start position P2 includes a first stage and a second stage. In the first stage of decompression, the movable part is moved from the decompression start position P1 toward the mold opening start position P2 not only by operating the mold clamping motor but also by utilizing the restoring force of the tie bars elastically stretched to apply the clamping force. In the second stage of decompression, the mold clamping motor is operated to move the movable part to the mold opening start position P2.

In the comparative example, the duration of the cooling step and the mold opening start time T2 are predetermined, and the time from the start to the end of decompression is set so that the movable part reliably reaches the mold opening start position P2 at the mold opening start time T2 after the end of the cooling step. Therefore, the comparative example causes the movable part to reach the mold opening start position P2 at an earlier time T2a than the mold opening start time T2. As a result, a standby time arises between the time T2a at which the movable part reaches the mold opening start position P2 and the mold opening start time T2, thereby causing a cycle loss.

In contrast, in the injection molding machine 10 according to the present embodiment, the control device 700 controls the position of the crosshead 151, which is a movable part of the mold clamping device 100, in the mold opening and closing direction of the mold device 800. The control device 700 moves the crosshead 151 from the decompression start position P1 toward the mold opening start position P2 at the decompression start time T1, as illustrated by the thick solid line in FIG. 4, thereby performing decompression. Furthermore, the control device 700 moves the crosshead 151 in the mold opening direction to perform mold opening at the time T2a when the crosshead 151 reaches the mold opening start position P2.

In addition, the control device 700 may, for example, as illustrated by the thick solid line in FIG. 4, reduce the moving speed of the crosshead 151 as a movable part at the mold opening start position P2. In this case, the moving speed of the crosshead 151 at the mold opening start position P2 may be zero or may not be zero. In other words, the control device 700 may start mold opening after bringing the crosshead 151 to a stop at the mold opening start position P2 at the end of decompression, or may start mold opening without stopping the crosshead 151 at the mold opening start position P2 at the end of decompression.

Furthermore, the control device 700 may, for example, as illustrated by the thick solid line in FIG. 5, maintain the moving speed of the crosshead 151 as a movable part both before and after the mold opening start position P2. The control device 700 may also, for example, as illustrated by the thick one-dot chain line and two-dot chain line in FIG. 6, delay the decompression start time T1 to times T1a or T1b and extend the cooling step so that the crosshead 151 reaches the mold opening start position P2 simultaneously with the mold opening start time T2.

The operation of the injection molding machine 10 and the control device 700 of the present embodiment will be described below.

As described above, the injection molding machine 10 according to the present embodiment includes the mold clamping device 100 and the control device 700. The mold clamping device 100 includes a crosshead 151 as a movable part configured to open and close the mold device 800. The control device 700 controls the position of the crosshead 151 in the mold opening and closing direction of the mold device 800 to perform decompression and mold opening. The control device 700 moves the crosshead 151 from the decompression start position P1 to the mold opening start position P2 to perform decompression, and upon the crosshead 151 reaching the mold opening start position P2, moves the crosshead 151 in the mold opening direction to perform mold opening.

With this configuration, the crosshead 151, as a movable part configured to open and close the mold device 800, can start mold opening at the same time as it reaches the mold opening start position P2 at the end of decompression. Therefore, according to the injection molding machine 10 according to the present embodiment, a smooth transition from decompression to mold opening can be achieved. This allows the decompression operation and mold opening operation of the mold clamping device 100 to be coordinated, eliminating unnecessary movements of the mold clamping device 100 from the end of decompression to the completion of mold opening, and enabling smooth operation of the mold clamping device 100 during this period. In addition, the waiting time of the crosshead 151 at the mold opening start position P2 can be eliminated, thereby reducing the molding cycle time.

In the injection molding machine 10 according to the present embodiment, the control device 700 reduces the moving speed of the crosshead 151 as a movable part at the mold opening start position P2.

With this configuration, noise caused by vacuum collapse in the cavity space 801 of the mold device 800 during the transition from decompression to mold opening can be reduced. In addition, as illustrated by the thick one-dot chain line in FIG. 6, by having the crosshead 151 reach the mold opening start position P2 simultaneously with the mold opening start time T2, the cooling step time can be extended, thereby suppressing sink marks in the molded product.

Furthermore, in the injection molding machine 10 according to the present embodiment, the control device 700 maintains the moving speed of the crosshead 151 as a movable part both before and after the mold opening start position P2.

With this configuration, as illustrated in FIGS. 4 and 5, the crosshead 151 can be brought to the mold opening start position P2 at an earlier time T2b than the time T2a at which the crosshead 151, whose moving speed has been reduced at the mold opening start position P2, would reach the mold opening start position P2. As a result, compared with the case where the moving speed of the crosshead 151 is reduced at the mold opening start position P2 during the transition from decompression to mold opening, the time required for the decompression step can be shortened, thereby further shortening the molding cycle. Accordingly, the injection molding machine 10 according to the present embodiment makes it possible to achieve high-cycle molding. In addition, as illustrated by the thick two-dot chain line in FIG. 6, by having the crosshead 151 reach the mold opening start position P2 simultaneously with the mold opening start time T2, the cooling step time can be further extended, enabling more reliable suppression of sink marks in the molded product.

The injection molding machine 10 according to the present embodiment is further provided with a clamping motor encoder 161 as a position detector configured to detect the position of the crosshead 151 as a movable part. The control device 700 controls the position of the crosshead 151 as a movable part based on the detection result of the mold clamping motor encoder 161 as a position detector.

With this configuration, the control device 700 can control the position of the crosshead 151 as a movable part using the detection results of the mold clamping motor encoder 161 provided in the injection molding machine 10.

In the injection molding machine 10 according to the present embodiment, the mold clamping device 100 includes a fixed platen 110, a movable platen 120, and a moving mechanism 102. The fixed platen 110 is attached to the fixed mold 810 of the mold device 800. The movable platen 120 is attached to the movable mold 820 of the mold device 800. The moving mechanism 102 moves the movable platen 120 relative to the fixed platen 110 in the mold opening and closing direction of the mold device 800. The moving mechanism 102 includes a toggle support 130, a tie bar 140, a toggle mechanism 150, a clamping motor 160, and a motion conversion mechanism 170. The toggle support 130 is disposed spaced from the fixed platen 110. The tie bar 140 connects the fixed platen 110 and the toggle support 130. The toggle mechanism 150 moves the movable platen 120 with respect to the toggle support 130 in the mold opening and closing direction. The mold clamping motor 160 operates the toggle mechanism 150. The motion conversion mechanism 170 converts the rotational motion of the mold clamping motor 160 into a linear motion. The toggle mechanism 150 includes a crosshead 151 as a movable part and a pair of link groups including a first link 152, a second link 153, and a third link 154. The crosshead 151 moves in the mold opening and closing direction by converting the rotational motion of the mold clamping motor 160 into a linear motion by the motion conversion mechanism 170. The pair of link groups are swingably connected to the fixed platen 110 and the toggle support 130 and extend and contract by the movement of the crosshead 151 in the mold opening and closing direction.

With this configuration, the control device 700 can control the mold clamping motor 160 to move the crosshead 151 as a movable part from the decompression start position P1 to the mold opening end position via the mold opening start position P2 at decompression start times T1, T1a, and T1b. The control device 700 can control the speed of the crosshead 151 as the movable part in the mold opening and closing direction by controlling the mold clamping motor 160 in the decompression step.

The control device 700 according to the present embodiment also controls the injection molding machine 10. The injection molding machine 10 includes a clamping device 100 having the crosshead 151 as a movable part configured to open and close the mold device 800. The control device 700 controls a position of the crosshead 151 in the mold opening and closing direction of the mold device 800 to perform decompression and mold opening. The control device 700 moves the crosshead 151 from the decompression start position P1 to the mold opening start position P2 to perform decompression, and moves the crosshead 151 in the mold opening direction to perform mold opening when the crosshead 151 reaches the mold opening start position P2.

With this configuration, mold opening can be started at the same time as the crosshead 151 as a movable part configured to open and close the mold device 800 reaches the mold opening start position P2 at the end of decompression. Therefore, in the control device 700 according to the present embodiment, the transition from decompression to mold opening of the injection molding machine 10 can be made smooth. Thus, the decompression operation of the mold clamping force by the mold clamping device 100 and the mold opening operation are interlocked to eliminate waste in the operation of the mold clamping device 100 from decompression to completion of mold opening, and the operation of the mold clamping device 100 from decompression to completion of mold opening can be performed smoothly. In addition, the waiting time of the crosshead 151 at the mold opening start position P2 can be eliminated, thereby reducing the molding cycle time.

As described above, according to the embodiment of the present disclosure, it is possible to provide an injection molding machine 10 and a control device 700 that can smoothly transition from decompression to mold opening.

Thus, the preferred embodiment of the present disclosure has been described above. However, the invention of the present disclosure is not limited to the embodiment described above. The embodiment described above can be applied with various modifications, substitutions, etc. without departing from the scope of the invention of the present disclosure. Each of the features described with reference to the embodiment described above may be appropriately combined as long as they are not technically inconsistent.

What is claimed is:

1. An injection molding machine comprising:
a mold clamping device including a movable part configured to open and close a mold device; and
a control device operatively connected to the movable part, wherein the control device includes:
one or more processors; and
a memory storing programmed instructions, which when executed the one or more processors, cause the control device to control a position of the movable part in both a mold opening direction and a mold closing direction of the mold device so as to perform:
(a) a decompression operation of moving the movable part from a decompression start position to a mold opening start position; and
(b) a mold opening operation of moving the movable part in the mold opening direction upon the movable part reaching the mold opening start position.

2. The injection molding machine according to claim 1, wherein a moving speed of the movable part is reduced at the mold opening start position.

3. The injection molding machine according to claim 1, wherein a moving speed of the movable part is maintained both before and after the mold opening start position.

4. The injection molding machine according to claim 1, further comprising:
a position detector configured to detect a position of the movable part,
wherein the position of the movable part is controlled based on a detection result of the position detector.

5. The injection molding machine according to claim 1, wherein the mold clamping device comprises:
a fixed platen to which a fixed mold of the mold device is to be attached;
a movable platen to which a movable mold of the mold device is to be attached; and
a moving mechanism configured to move the movable platen relative to the fixed platen in the mold opening and closing direction,
wherein the moving mechanism comprises:
a toggle support disposed at a distance from the fixed platen;
tie bars connecting the fixed platen and the toggle support;
a toggle mechanism configured to move the movable platen in the mold opening and closing direction relative to the toggle support;
a mold clamping motor configured to actuate the toggle mechanism; and
a motion conversion mechanism configured to convert a rotational motion of the mold clamping motor into a linear motion,
wherein the toggle mechanism comprises:
a crosshead, serving as the movable part, that moves in the mold opening and closing direction by converting the rotational motion of the mold clamping motor into the linear motion via the motion conversion mechanism; and
a pair of link groups swingably connected to the movable platen and the toggle support, and configured to extend and contract in response to the movement of the crosshead in the mold opening and closing direction.

6. A control device for an injection molding machine, the injection molding machine including a mold clamping device having a movable part configured to open and close a mold device, and the control device operatively connected to the movable part, the control device comprising:
one or more processors; and
a memory storing programmed instructions, which when executed the one or more processors, cause the control device to control a position of the movable part in both a mold opening direction and a mold closing direction of the mold device so as to perform:
(a) a decompression operation of moving the movable part from a decompression start position to a mold opening start position; and
(b) a mold opening operation of moving the movable part in the mold opening direction upon the movable part reaching the mold opening start position.
